(19) United States
(12) Patent Application Publication
(10) Pub. No.: US 2018/0252592 A1
(43) Pub. Date: Sep. 6, 2018

(54) Thermometer

(71) Applicants: Parot Victor Charoonsophonsak, Pullman, WA (US); Annalise Nancy Miller, Pullman, WA (US)

(72) Inventors: Parot Victor Charoonsophonsak, Pullman, WA (US); Annalise Nancy Miller, Pullman, WA (US)

(21) Appl. No.: 15/909,718

(22) Filed: Mar. 1, 2018

Related U.S. Application Data
(60) Provisional application No. 62/465,710, filed on Mar. 1, 2017.

(51) Int. Cl. G01K 3/04; G06F 9/06; G01K 1/02; G08B 5/36; A23C 3/02

(52) U.S. Cl. CPC G01K 3/04; G06F 9/06; G01K 2207/02; G08B 5/36; A23C 3/02; G01K 1/022

(57) ABSTRACT

A pasteurization detection apparatus including a thermometer to detect a temperature of a product and determine that the product has endured a pasteurization temperature for a predetermined amount of time. The pasteurization device may also include at least one indicator configured to be actuated based on the product enduring the pasteurization temperature for the predetermined amount of time.

### CROSS REFERENCE TO RELATED APPLICATIONS

This application claims priority to U.S. Provisional Application No. 62/465,710, filed Mar. 1, 2017, entitled “Smart Thermometer,” the entirety of which is herein incorporated by reference.

### BACKGROUND

Antibiotic resistance occurs when an antibiotic has lost its ability to effectively control a bacterial growth. The bacteria are resistant in the sense that they continue to multiply and grow despite the administration of therapeutic levels of antibiotics. Although antibiotic resistance occurs naturally, the use of antibiotics has caused difficulties in treating a growing number of infections such as pneumonia, tuberculosis, and gonorrhea.

Milk is consumed in many countries around the world as an essential source of vitamins and nutrients. Milk harvested from cattle or other animals treated with antibiotics, however, often results in antibiotic resistant bacteria being passed down to the consumer. Drinking untreated milk that contains antibiotic resistant bacteria can in turn cause foodborne illnesses. If contracted, consumers may seek treatment or may risk becoming sick or potentially dying. However, in some parts of the world, treatment is not readily available. The use of antibiotics in animals has therefore led to an emergence and presence of antibiotic resistant bacteria in humans.

While milk may be pasteurized prior to consumption to kill the antibiotic resistant bacteria, existing measurement devices that detect pasteurization are not intuitive or durable, and are incapable of withstanding repeated use in many harsh environments found throughout the world. As a result, large amounts of milk consumed around the world is often either not treated at all, or is poorly treated, prior to consumption.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a front perspective view of an example thermometer.

FIG. 2 is a rear perspective view of the example thermometer of FIG. 1.

FIG. 3 is a diagram of an illustrative computing architecture of the example thermometer of FIG. 1.

FIG. 4 is a flow diagram illustrating an example method using example the thermometer of FIG. 1.

### DETAILED DESCRIPTION

As discussed above, there has been an increase in foodborne illnesses given that a large number of people in the world drink milk that is untreated (i.e., not pasteurized). In part, the emergence of antibiotic resistant bacteria stems from the overuse or use of antibiotics in animals. In addition, with the lack of measurement devices or instruments that indicate pasteurization, for instance, it is difficult to identify whether milk is heated to safe pasteurization temperatures.

While boiling milk may kill harmful bacteria, such practice is not accepted in many cultures around the world given the sacredness of milk. Furthermore, boiling milk often disrupts its taste and may destroy beneficial nutrients. Fortunately, the technique of pasteurization was long ago discovered to be an effective manner of cleansing milk without needing to boil the milk. More specifically, pasteurization occurs by heating milk to specific temperatures for certain periods of time without reaching the boiling point.

Although there are many known thermometers to detect temperature, existing thermometers cannot withstand harsh environments, are often too complex for use in third-world or developing countries, and lack capabilities to collect real time data associated with the pasteurization of milk. Accordingly, people continue to drink milk that is poorly treated because of the lack measurement devices that identify whether milk has been heated to safe pasteurization temperatures. As such, a growing population is becoming ill and the increase of antibiotic resistant bacteria is furthered.

In light of the above deficiencies, this application discusses a device that is a robust data collecting thermometer to decrease the emergence of antimicrobial resistance in relation to pasteurization. In turn, thermometers according to this application may be used to ensure proper milk pasteurization, may eliminate harmful bacteria within milk, such as antibiotic resistant bacteria, and may lead to a decrease in antibiotic resistant bacteria in humans. In some instances, thermometers according to this application may include a housing, intuitive indicators that indicate whether milk is safely pasteurized, and hardware or components that permit data acquisition to collect and store data during the pasteurization process. Therefore, embodiments of thermometers discussed herein may lessen the emergence and transmission of antibiotic resistance through providing an intuitive device that is easy to operate.

The housing of the thermometer may be easily handled, grasped, and made of durable materials that withstand harsh and extreme environments, such as those found in developing countries. Notably, as developing countries frequently lack proper pasteurization facilities or equipment, harvested milk is often heated over stoves or wood fires and in environments where conventional thermometers may be susceptible to easily breaking. Thermometers discussed herein may therefore be made of durable materials and capable of withstanding repeated and cyclic use in these environments. In some instances, the thermometer may be manufactured of high strength materials that are less prone to breaking compared to conventional liquid mercury thermometers, for instance, that are encased in glass or other fragile materials. By way of a non-limiting example, the housing may be manufactured of nylon or other high-strength and high-temperature polymers or metals.

The thermometer may also include a clip, hanger, or other attachment mechanism that is disposed along or on the housing. The attachment mechanism may suspend a thermostat of the thermometer within the milk. In some instances, the thermometer may be easily clipped onto a side of a pot or pan used to heat the milk in order to measure temperature. In some instances, the attachment mechanism may be adjustable along a length or height of the thermometer to suspend the thermostat at different positions within the milk.

Compared to existing thermometers that are not easily readable, thermometers discussed herein may eliminate the burden of reading or deciphering temperature measurements or scales on the thermometer. In particular, given that many of the impoverished people in developing countries have little formal training, are uneducated, and/or may be illiterate, frequently, the people within this group are unable to read scales or monitor temperature values. To this end, embodiments of thermometers discussed herein may be placed in milk and may output an indication such as a light, vibration, or audible tone that indicates when the milk is pasteurized. By way of non-limiting examples, indicators configured to output the indication may include one or more indicator lights, such as a light emitting diode (LED), one or more speakers, or one or more vibrational motors.

In some instances, the indicators may be disposed at an end opposite to where the thermostat is located on the housing. When the thermometer is clipped or otherwise attached to the pot, the indicator may be displayed exterior to the pot to be easily visible. For instance, when the indicator includes an LED, light emitted by the LED may be visible above or outside a rim of the pot.

As noted above, the indication may be outputted after the milk reaches a proper pasteurization temperature for a threshold period of time. The thermometer may therefore analyze the temperature of the milk as the milk is being heated. In some instances, the thermometer may continuously analyze the temperature of the milk to determine whether the temperature exceeds a temperature threshold for the threshold period of time. The temperature threshold may correspond to a pasteurization temperature of milk.

Maintaining the temperature of the milk at or above the pasteurization temperature, for the threshold period of time, may kill or reduce the amount of harmful bacteria. Therefore, through actuating the indicator (e.g., initiating an indication output of light, sound, vibration, etc.), the indication output may serve to notify consumers that the temperature of the milk remained at or above the pasteurization temperature for the threshold period of time and may be safe to drink. For instance, when the indicator includes one or more lights (e.g., LEDs, OLEDs, etc.), light may be emitted by the indicator when the temperature of the milk is maintained at or above a temperature threshold for the threshold period of time. By way of non-limiting examples, the indicator may be actuated to indicate that the milk is pasteurized once the temperature of the milk reaches 72° C. for threshold periods of 15 seconds, 30 seconds, or 60 seconds. If the temperature does not exceed the temperature threshold for the threshold period of time, the milk may be considered not safely pasteurized and the indicator may not be actuated by the thermometer.

Compared to conventional methods, these forms of indications may make the thermometer more perceptive, instinctive to use, and may demand little training or literacy. In doing so, the thermometer may be easily integrated into communities that include large numbers of uneducated, unsophisticated, or untrained individuals. The thermometer of the instant application may therefore reduce the impracticalities associated with conventional thermometers with respect to reading and interpreting measurements by providing an intuitive indication when the milk is pasteurized. Moreover, as developing countries often lack adequate lighting for activities done after the sun sets, or even access to electricity, an embodiment of a thermometer using one or more light-emitting indicators may be useful in low lighting environments or conditions.

In some instances, the thermometer may also collect data associated with the pasteurization process. The data collected may aid in research and may be used to study the emergence of antibiotic resistant bacteria in relation to poor milk heating practices. In some instances, the thermometer may collect and record various temperatures throughout the pasteurization process and may wirelessly transmit data for analysis. By way of non-limiting examples, the thermometer may be configured to collect data associated with how many times the pasteurization temperature was reached, how many times the pasteurization temperature was not reached, the length of time the milk was maintained at, below, or above the pasteurization temperature, dates and times associated with the data collection, and/or a frequency at which the thermometer is used.

In some instances, the thermometer may be configured to transition between a low power consumption and low functionality state to a normal operating state. For instance, at a point when the thermometer senses a temperature of 72° C., which in some instances is the pasteurization temperature of milk, the thermometer may transition from the low power consumption and low functionality state to the normal operating state. In the normal operating state, more computing resources may be used, such as recording data associated with pasteurization or transmitting the recorded data to remote computing devices.

In addition, while the disclosure herein pertains to using the thermometer in conjunction with pasteurizing milk, it is to be understood that in some instances the thermometer may be implemented for use in other fluids or mediums.

### Example Thermometer

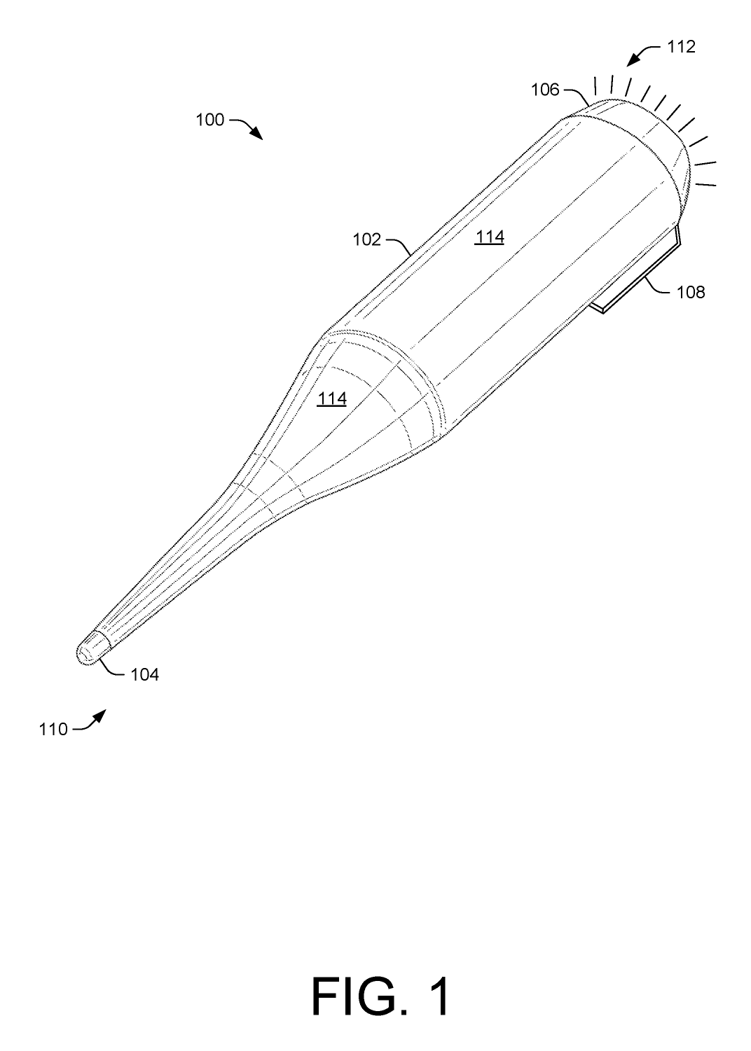

FIG. 1 illustrates a perspective view of a thermometer 100, showing a housing 102, a thermostat 104, an indicator 106, and an attachment mechanism 108. The housing 102 includes a first end 110 and a second end 112 opposite the first end 110. Interposed between the first end 110 and the second end 112 is a body 114 of the housing 102. In some instances, the housing 102 may taper from the second end 112 towards the first end 110. The body 114 of the housing 102 may be easily clutched or grasped by a user. The housing 102 may also include grips, finger depressions, or other indentations or protrusions that allow the housing 102 to be handled by the user.

The housing 102 may include materials that are capable of withstanding high temperatures for sustained periods of time. For instance, the housing 102 may endure being placed over fires used to heat and pasteurize milk. The materials of the housing 102 may be sanitized or cleaned using chemicals and may be durable to withstand being stepped on or dropped. By way of non-limiting examples, materials of the housing 102 may include metals, such as stainless steel, plastics, such as polyethylene, nylon, or polypropylene, or any combination thereof.

In addition, the housing 102 may be manufactured from a single piece of material or may include multiple components that are assembled together.

The thermostat 104 may be located at the first end 110 of the housing 102. As discussed in detail herein, the thermostat 104 is configured to be disposed within milk and may provide temperature data of the milk during pasteurization.

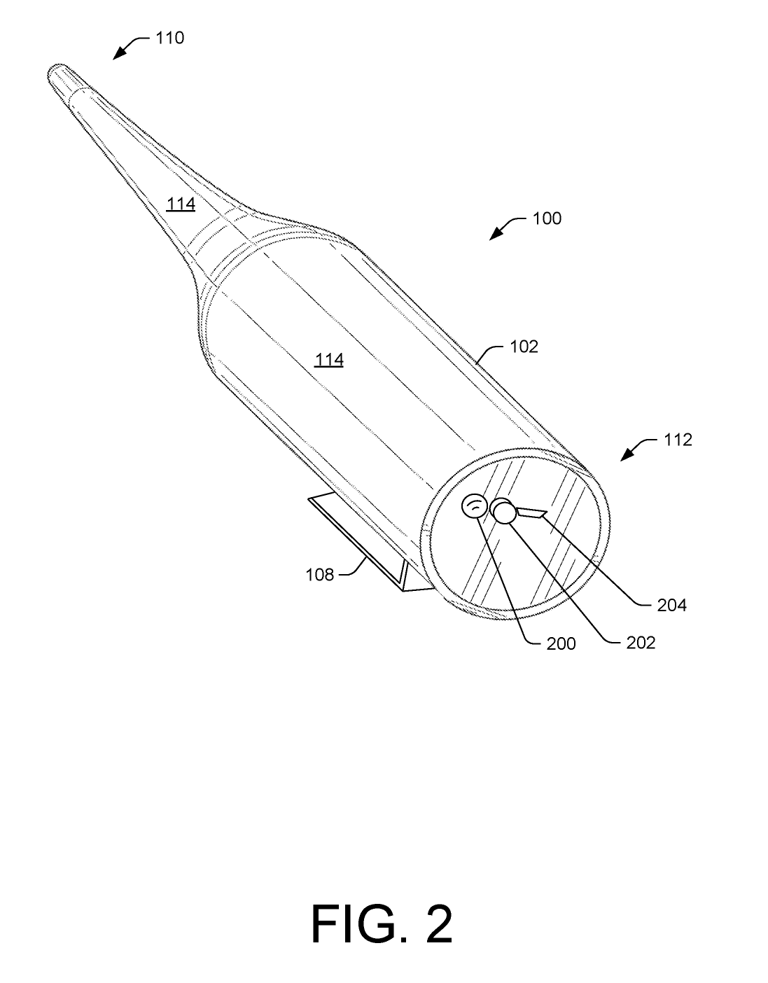

In an embodiment, the indicator 106 may be located at the second end 112 of the housing 102. The indicator 106 may include one or more light sources (see FIG. 2), such as a light emitting diode (LED) that is configured to be actuated as an indication of when the milk has maintained the pasteurization temperature for a threshold period of time. The indicator 106 is shown as a bulbous or spherically-shaped feature designed to be easily viewable from multiple directions. The material used for the housing of the indicator 106 may translucent to allow light to pass therethrough. For instance, when the indicator 106 includes the one or more light sources, light emitted by the one or more light sources is visible through a wall of the housing of the indicator 106. In some instances, the indicator 106 may also include a diffusive material therein or thereon to assist in evenly distributing light from the one or more light sources (not shown) of the indicator 106.

In some instances, the indicator 106 housing may be tinted with various colors, and/or the one or more light sources may include lights of different colors. Thus, when the one or more light sources are illuminated, depending on the condition of the milk, the indicator 106 may indicate that the milk is either not yet ready or that it is pasteurized. For instance, the indicator 106 may display a green illumination when the milk is ready or a red illumination if the milk is not done being pasteurized.

Additionally, or alternatively, the thermometer 100 may also include one or more speakers and/or one or more vibrator motors that are actuated to indicate when the milk is pasteurized. For instance, the one or more speakers may output an audible response and/or the one or more vibrator motors may vibrate when the milk is pasteurized. In some instances, the one or more speakers and/or the one or more vibrator motors may be disposed on or within the housing 102, such as within the indicator 106, or spaced apart from the indicator 106.

Coupled to the housing 102 may be the attachment mechanism 108. The attachment mechanism 108 may be configured to suspend the thermometer 100 within the milk or may secure the thermometer 100 to equipment used to pasteurize milk. In some instances, the attachment mechanism 108 may include a clamp, clip, bracket, or other fastener. The attachment mechanism 108 may therefore be clamped, clipped, or hung on or along a sidewall of a pot used to heat milk to couple the thermometer 100 thereto. In some instances, the attachment mechanism may dispose the housing 102 of the thermometer 100 away from sidewalls of the pot, so as to avoid melting or heating the housing 102. In some instances, the attachment mechanism 108 may be adjusted along the housing 102 of the thermometer 100 in order to change a suspension height of the thermostat 104 within the milk. That is, as different pots may be used to pasteurize milk, to prevent the thermostat 104 from resting or contacting a bottom of the pot, for instance, the attachment mechanism 108 may be adjusted.

As discussed in more detail herein, the thermometer 100 may include electrical circuit components (not shown) that reside within the housing 102 that receive signals from the thermostat 104 to produce the indication (e.g., via the indicator 106) when the pasteurization temperature is maintained for the threshold period of time and/or to begin recording data associated with the pasteurization process. For instance, the components may be configured to accumulate information overtime such as temperature, date and time, how many times the pasteurization temperature is reached, how many times the pasteurization temperature is not reached, and so forth.

To power the components, the thermometer 100 may include a battery or a rechargeable battery and a locking mechanism to secure the battery within the housing 102. Additionally, or alternatively, the thermometer 100 may be capable of receiving mains powered or may include solar elements to charge the battery.

The thermometer 100 may also be sealed so as to be waterproof or water-resistant to protect the components residing within the housing 102.

FIG. 2 illustrates a rear perspective view of the thermometer 100, showing the indicator 106 removed to display components residing beneath or within the indicator 106. In some instances, the second end 112 may include one or more light sources 200, a button 202, and a port 204. As mentioned above, the one or more light sources 200 may be configured to emit light out of the indicator 106. In some instances, the indicator 106 may be removably coupled to the second end 212 of the housing 102 through being threaded or snap-fitted onto the housing 102.

The one or more light sources 200 may include a plurality of lights. The plurality of lights may have different colors, may be of the same color, or may be individually, selectively, or collectively controllable.

The button 202 may be actuated to turn on and/or off the thermometer 100 to begin sensing a temperature of the milk. Additionally, and/or alternatively, actuation of the button 202 may cause the thermometer 100 to begin transmitting data associated with the pasteurization process.

The port 204 may have contacts or input/output ports, such as an auxiliary or USB port, that installs updates or test software/hardware components of the thermometer 100 or transfers information collected or stored by the thermometer 100. Additionally, in an embodiment, the battery within the thermometer may be charged via port 204.

In addition, although the one or more light sources 200, the button 202, and the port 204 are shown as being disposed on the housing 102 at the second end 112, the one or more light sources 200, the button 202, and the port 204 may be located elsewhere along the body 114 of the housing 102.

### Example Architecture

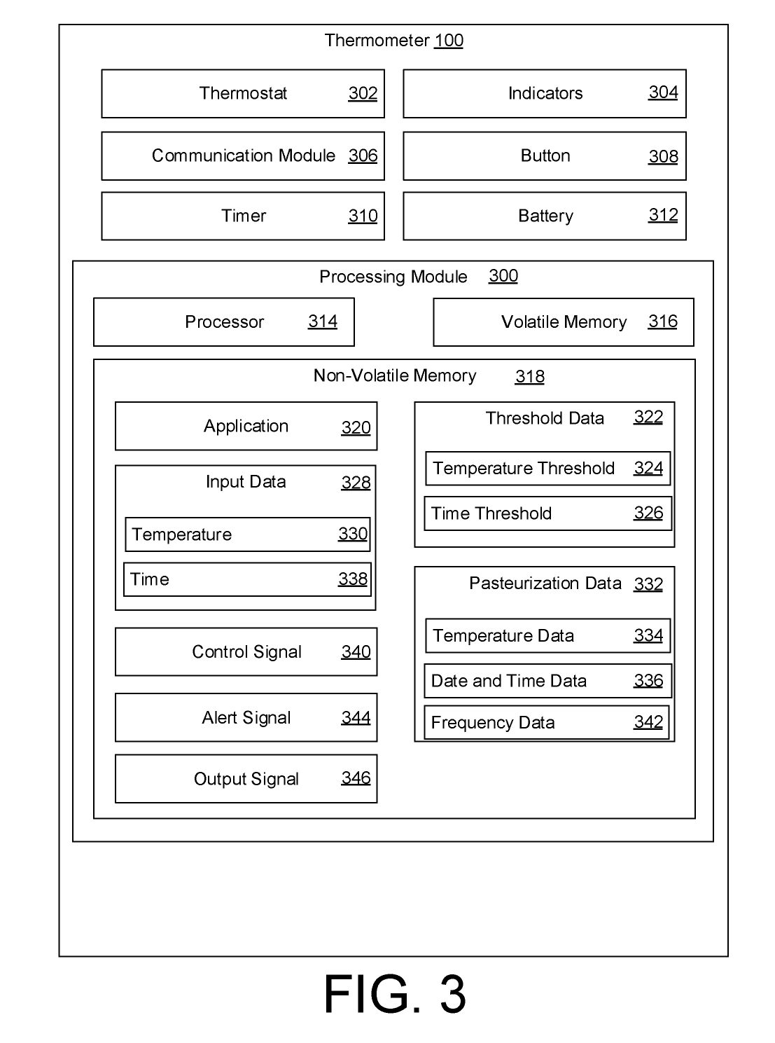

FIG. 3 is a functional block diagram illustrating an embodiment of a thermometer 100 according to various aspects of the present disclosure. The thermometer 100 may include a processing module 300 that is operatively connected to a thermostat 302, one or more indicators 304, a communication module 306, a button 308, and a timer 310. The thermometer 100 may also include a battery 312 communicatively coupled to the processing module 300, the thermostat 302, the one or more indicators 304, the communication module 306, the button 308, and the timer 310 to provide power. The thermostat 302 may correspond to the thermostat 104, the indictors 304 may correspond to the indicator 106, and the button 308 may correspond to the button 202.

The processing module 300 may include a processor 314, volatile memory 316, and non-volatile memory 318, which includes an application 320 in the form of instructions that are executed by the processor 314 to perform operations that implement desired functionality of the thermometer 100, including the functionality described herein.

The application 320 may cause the processor 314 to store threshold data 322 associated with the pasteurization of milk. In some instances, the threshold data 322 may include a temperature threshold 324 that represents a pasteurization temperature of milk. Additionally, the threshold data 322 may include a time threshold 326 that represents a threshold period of time associated with pasteurizing milk. That is, as alluded to previously, to pasteurize milk, a temperature threshold represented by the temperature threshold 324 may be maintained or exceeded for a threshold period of time represented by the time threshold 326.

The threshold data 322 may correspond to effective pasteurization such as heating the milk to at least 145° F. for 30 minutes, high-temperature short-time (HTST) pasteurization such as heating the milk to at least 161.6° F. for 15 seconds, or ultra-heat treatment (UHT) such as heating the milk to at least 280° F. for a minimum of two seconds.

The application 320 may cause the processor 314 to receive input data 328 from the thermostat 302. In some instances, the input data 328 may include data generated in response to an input received by the button 308. Additionally, or alternatively, as discussed herein, the input data 328 may be received when the temperature threshold 324 is reached. The input data 328 may include a temperature 330 received from the thermostat 302 that represents a temperature of the milk.

The application 320 may cause the processor 314 to analyze the input data 328 to determine whether the input data 328 is indicative of a pasteurization temperature. For instance, the application 320 may cause the processor 314 to compare the input data 328 to the threshold data 322 to determine whether the input data 328 received from the thermostat 302 exceeds the temperature threshold 324.

The application 320 may cause the processor 314 to record pasteurization data 332 associated with the pasteurization of milk. The pasteurization data 332 may include temperature data 334 received from the thermostat 302 and/or date and time data 336 received from the timer 310. In some instances, the application 320 may cause the processor 314 to receive, generate, and/or record the pasteurization data 332 based at least in part on the temperature reaching the temperature threshold. That is, once the temperature of the milk has at least reached the temperature threshold represented by the temperature threshold 324, the processor 314 may continue to receive the input data 328 and may record the temperature data 334 and/or the date and time data 336 in the volatile memory 316. In some instances, the application 320 may cause the processor 314 to record the temperature data 334 in association with the date and time data 336.

With further reference to FIG. 3, the application 320 may cause the processor 314 to analyze the input data 328 to determine whether the temperature exceeds the temperature threshold for a threshold period of time. For instance, the application 320 may cause the processor 314 to analyze a time represented by time 338. In some instances, and as shown in FIG. 3, the input data 328 may include the time 338, which in some instances, may be generated and/or received from the timer 310. The processor 314 may compare the time threshold represented by the time threshold 326 to determine whether the temperature has exceeded the temperature threshold represented. In response to determining that the temperature exceeds the temperature threshold 324 for the time threshold 326, the application 320 may cause the processor 314 to generate and/or record an indication that the milk has been pasteurized (i.e., that the temperature exceeds the temperature threshold 324 for the time threshold 326). Alternatively, the application 320 may cause the processor 314 to generate and/or record an indication that the milk has not been pasteurized (i.e., that the temperature has not exceeded the temperature threshold 324 for the time threshold 326).

The application 320 may cause the processor 314 to generate a control signal 340. In some instances, the control signal 340 may be generated based on the temperature being at or above the temperature threshold 324 for the time threshold 326. The application 320 may cause processor 314 to send the control signal 340 to the one or more indicators 304. In some instances, in response to receiving the control signal 340, the one or more indicators 304 may output a response, feedback, or an indication. The indication may serve to indicate that the temperature has reached the temperature threshold 324 for the time threshold 326 and that the milk is pasteurized.

Turning briefly to the one or more indicators 304 and by way of non-limiting examples, the one or more indicators 304 may include one or more light sources, vibrational motors, or speakers. However, any other indicators programmable and capable of providing visual, touch, or audible indications may be used. For instance, in response to receiving the control signal 340, the one or more light sources may therefore emit light or the speaker may output an audible tone. The control signal 340 may be formatted for consumption or output by the one or more indicators 304 and depending on the type of the one or more indicators 304 implemented.

In some instances, the control signal 340 may be output for a predetermined amount of time by the one or more indicators 304. For instance, the one or more light sources may be illuminated for a predetermined amount of time after the temperature has exceeded the temperature threshold 324 for the time threshold 326. Thereafter, for instance, the processor 314 may terminate sending the control signal 340 to the one or more indicators 304 or alternatively, the control signal 340 may cause the one or more indicators 304 to output the indication for the predetermined amount of time.

In some instances, the control signal 340 may represent multiple control signals that are sent to the one or more indicators 304. For instance, the application 320 may cause the processor 314 to send a first control signal when the temperature threshold 324 is exceeded and may send a second control signal when the temperature has been maintained for the time threshold 326. In some instances, the first control signal and the second control signal may represent, for instance, different audible tones to be output by one or more speakers or different colors or illuminations to be output by one or more light sources.

By way of an additional example, once the temperature exceeds the temperature threshold 324 for the time threshold 326, the control signal 340 may cause one or more light sources, for instance, to output a green tone or hue, representing that the milk is pasteurized. Comparatively, if the milk has not met the temperature threshold 324 for the time threshold 326, the control signal 340 may cause the one or more light sources to output a red tone or hue, indicating that the milk is not pasteurized. In other instances, the control signal 340 may cause the one or more light sources to gradually or progressively update to provide a real time indication of the pasteurization process. By way of a non-limiting example, the control signal 340 may cause the one or more light sources to transition between red, yellow, and green, where red indicates that the milk is not pasteurized and green indicates that the milk is pasteurized. The control signal 340 may also cause the one or more light sources to transition through different colors or shades of red, yellow, and green, where shades of yellow may indicate a real-time status or progress of the pasteurization process. The shade of yellow indicated by the one or more light sources may represent a remaining time before the milk is pasteurized.

In some instances, once the temperature has exceeded the temperature threshold 324 for the time threshold 326, the application 320 may cause the processor 314 to terminate recording the temperature data 334 received from the thermostat 302 and/or the date and time data 336 received from the timer 310. For instance, once the milk is pasteurized, the milk may be removed from a heating source, causing the temperature of the milk to eventually fall below the temperature threshold 324. In doing so, the processor 314 may terminate recording the temperature data 334 and/or the date and time data 336. However, to continue indicating that the milk is pasteurized, the control signal 340 may be transmitted by the processor 314 to the one or more indicators 304 for a predetermined amount of time. As such, even though the temperature may fall below the temperature threshold 324, the one or more indicators 304 may still indicate the milk is pasteurized.

In some instances, the application 320 may cause the processor 314 to transition from a low operational state to an increased operational state. That is, as noted above, the pasteurization data 332 may be recorded by the processor 314 in response to determining the temperature threshold 324 is satisfied. To reduce a usage or draw of the battery 312, the pasteurization data 332 may be recorded once the temperature threshold 324 has been met. Additionally, or alternatively, the pasteurization data 332 may cease to be recorded once the temperature of the milk falls below the temperature threshold 324. In some instances, the increased operational state may include increased computational resources or an increased power consumption.

The application 320 may cause the processor 314 to generate frequency data 342 associated with the pasteurization. For instance, the processor 314 may include a detection count corresponding to the frequency data 342 that may represent how many times the temperature threshold 324 is exceeded for the time threshold 326, how many times the temperature threshold 324 does not exceed the time threshold 326, and/or how often or frequent the thermometer 100 is used (e.g., via the date and time data 336 or via receiving an indication that the button 308 is turned on/off).

In some instances, the pasteurization data 332 may include data that is used to provide a correlation between a reduction in antibiotic resistance caused by a pasteurized product. For instance, the application 320 may cause the processor 314 to analyze the temperature data 334 and/or the date and time data 336 to determine whether there is a reduction in antibiotic resistance associated with pasteurizing milk. This determination may be used to determine illnesses associated with consumption of an unpasteurized product, such as milk. In some instances, this correlation may be between the temperature threshold 324 and an illness associated with consumption of an unpasteurized product or between the time threshold 326 and an illness associated with consumption of an unpasteurized product.

With further reference to FIG. 3, the application 320 may cause the processor 314 to generate an alert signal 344. The alert signal 344 may be generated in response to the processor 314 determining that a temperature represented by the temperature data 334 is approaching an upper threshold limit. In some instances, the upper threshold limit may be included within or represented within the temperature threshold 324. The upper threshold limit may indicate a boiling point or near boiling point of the milk. In some instances, the temperature threshold 324 may be associated with an elevation or climate in which the thermometer 100 resides to accurately indicate a boiling point.

The processor 314 may send the alert signal 344 to the one or more indicators 304 for output to notify or warn a user that the milk is reaching a boiling point. In some instances, the alert signal 344 may be different than the control signal 340 and in doing so, the one or more indicators 304 may output a different indication than represented by the control signal 340. Additionally, the processor 314 may continue analyzing the input data 328 and/or the temperature data 334 to transition between sending the output signal 340 and the alert signal 344. For instance, after the processor 314 generates and/or transmits the alert signal 344, the processor 314, at a later time, may determine that the temperature has receded below the upper threshold limit and may terminate sending the alert signal 344.

The application 320 may cause the processor 314 to transmit the pasteurization data 332 to remote devices using the communication module 306 and/or via wired technologies (e.g., wires, universal serial bus (USB), fiber optic cable, etc.), wireless technologies (e.g., radio frequencies (RF), cellular, mobile telephone networks, satellite, Bluetooth, etc.), or other connection technologies. In some instances, the pasteurization data 332 may be transmitted, by the processor 314 using communication module 306, in the form of an output signal 346. For instance, using Bluetooth or a wireless connection, the processor 314 may transmit the output signal 346 to the remote devices. By way of non-limiting examples, the remote devices may include servers or computing devices such as tablets, laptops, or cellular devices. In some instances, the application 320 may configure the processor 314 to generate the output signal 346 in response to the temperature threshold 324 being met for the time threshold 326.

Additionally, in some embodiments, the thermometer may omit one or more of the components shown in FIG. 3 and/or may include one or more additional components not shown in FIG. 3.

### Example Process

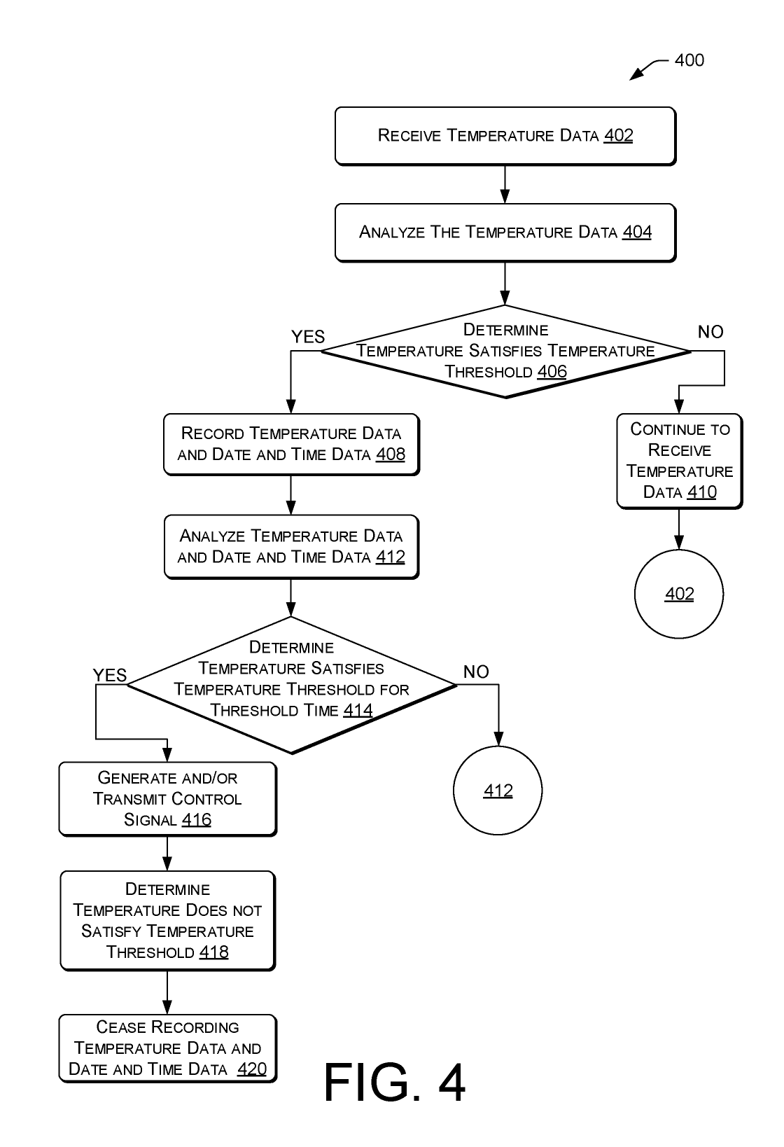

FIG. 4 illustrates an example process 400 associated with pasteurizing milk. In some instances, the operations of the example method 400 may be performable by the thermometer 100 or by other devices or systems. Further, each process described herein is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

At operation 402, temperature data may be received. In some instances, the temperature data may correspond to a temperature of milk using the thermometer 100. For instance, the thermometer 100 may be attached to a pot that contains milk and a thermostat of the thermometer may read the temperature data associated with the temperature of the milk.

At operation 404, the temperature data may be analyzed. In some instances, the analysis may involve comparing temperature data against a temperature threshold.

At operation 406, a determination is made whether the temperature represented in the temperature exceeds the temperature threshold. If the temperature exceeds the temperature threshold, the process may continue to operation 408. If the temperature does not exceed the temperature threshold, the process may continue to operation 410, after which the operation 402 is repeated to continue determining whether the temperature represented by the temperature data satisfies the temperature threshold (e.g., the operation 406).

At operation 408, the temperature data and date and time data may be recorded and/or stored. That is, once the temperature has reached the temperature threshold, the temperature data and the date and time data may be recorded by the thermometer. In some instances, the temperature data may be received from the thermostat while the date and time data may be received by a timer. In some instances, the process 400 may associate the temperature data with the date and time data in order to indicate when the temperature data is received and/or recorded.

Next, at operation 412, the temperature data and the date and time data may be analyzed to determine whether the temperature represented by the temperature data is maintained for a time threshold. After analyzing the temperature data and the date and time data, the process 400 may proceed to operation 414, where the process 400 determines whether the temperature satisfies the temperature threshold for the time threshold. If the temperature does not satisfy the temperature threshold for the time threshold, the operation 412 may repeated to continue determining whether the temperature satisfies the temperature threshold for the time threshold.

If at the operation 414 the temperature satisfies the temperature threshold for the time threshold, at operation 416 a control signal may be generated and/or transmitted to one or more indicators. In some instances, the control signal may cause one or more indicators to output an indication. For instance, the control signal may be transmitted to the one or more indicators, and in response to receiving the control signal, the one or more indicators may emit or output the indication. For instance, the one or more indicators may include a light source that is configured to emit a visual indication in response to receiving the control signal. In some instances, the control signal may be output for a predetermined period of time or the control signal may be transmitted to the one or more indicators for a predetermined period of time.

At operation 418, the process 400 may continue receiving temperature data to determine whether the temperature falls below the temperature threshold. In some instances, this may be, for instance, in response to the milk reaching the pasteurization temperature and the milk being subsequently removed from a heat source. In some instances, the process 400 may thereafter proceed to operation 420 where recording the temperature data and the date and time data is terminated.

### Conclusion

While various examples and embodiments are described individually herein, the examples and embodiments may be combined, rearranged and modified to arrive at other variations within the scope of this disclosure. In addition, although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An apparatus, comprising:
a housing;
a thermostat;
at least one indicator;
one or more processors; and
memory including instructions executable by the one or more processors, which, when executed, perform operations including:
sensing, by the thermostat, a temperature at or above a temperature threshold;
recording, based at least in part on sensing the temperature at or above the temperature threshold, temperature data and time data;
executing based at least in part on the temperature being at or above the temperature threshold for a predetermined amount of time, an indication to the at least one indicator, the at least one indicator being configured to output a response represented by the indication; and
terminating, based at least in part on the temperature falling below the temperature threshold, recording of the temperature data and time data.

2. The apparatus according to claim 1, wherein the operations performed by the one or more processors further include terminating, based at least in part on the response being output for a predetermined amount of time, executing of the indication to the at least one indicator.

3. The apparatus according to claim 1, wherein the housing includes a first end and a second end, and wherein the thermostat is disposed at the first end and the at least one indicator is disposed at the second end.

4. The apparatus according to claim 1, wherein the at least one indicator includes at least one light emitting diode (LED).

5. The apparatus according to claim 1, wherein the at least one indicator includes a plurality of lights, and wherein each of the plurality of lights has a different color.

6. The apparatus according to claim 1, wherein the housing is made of a high-strength and high-temperature polymer.

7. A pasteurization detection apparatus, comprising:
a thermometer configured to:
detect a temperature of a product, and
determine that the product has endured a pasteurization temperature for at least a predetermined amount of time; and
at least one indicator light configured to illuminate based, at least in part, on the product enduring the pasteurization temperature for at least the predetermined amount of time.

8. The apparatus according to claim 7, wherein the at least one indicator light includes at least one LED.

9. The apparatus according to claim 7, further comprising a wireless transmitter configured to transmit at least temperature data of the product and time data of the product.

10. The apparatus according to claim 7, further comprising memory configured to store temperature data and time data detected by the thermometer.

11. The apparatus according to claim 7, wherein the apparatus includes a housing having a first end, a second end, and a body interposed between the first end at the second end, and wherein the thermometer is disposed at the first end and the at least one light indicator is disposed at the second end.

12. The apparatus according to claim 11, further comprising an attachment mechanism coupled to the body of the housing.

13. A method for detecting pasteurization, the method comprising:
sensing a temperature of a product;
receiving, based at least in part on the temperature of the product exceeding a temperature threshold, temperature data corresponding to the temperature of the product, the temperature data being stored in association with a time value;
causing, based at least in part on the temperature of the product exceeding the temperature threshold for a time threshold, at least one indicator to output an indication; and
terminating, based at least in part on sensing the temperature of the product below the temperature threshold, storing of the temperature data corresponding to the temperature of the product.

14. The method according to claim 13, wherein the temperature threshold is a first temperature threshold and the first indication is a first indication, the method further comprising:
determining, based at least in part on receiving the temperature data, that the temperature of the product exceeds a second temperature threshold, the second temperature threshold being greater than the first temperature threshold; and
causing, based at least in part on the temperature of the product exceeding the second temperature threshold, the at least one indicator to output a second indication, the second indication being different than the first indication.

15. The method according to claim 13, wherein the at least one indicator is configured to output the indication for a predetermined amount of time.

16. The method according to claim 13, further comprising terminating, based at least in part on the temperature of the product falling below the temperature threshold, the at least one indicator to output the indication.

17. The method according to claim 13, wherein the at least one indicator includes at least one indicator light, and wherein the indication includes the at least one indicator light illuminating.

18. The method according to claim 13, wherein the at least one indicator includes at least one speaker, and wherein the indication includes the at least one speaker emitting sound.

19. The method according to claim 13, wherein the indicator is a first indicator, the method further comprising:
causing, based at least in part on the temperature of the product exceeding the temperature threshold, the at least one indicator to output a second indication, and wherein the causing the at least one indicator to output the first indication occurs after the at least one indicator outputs the second indication.

20. The method according to claim 13, wherein the temperature data is stored in association with a time value until the temperature of the product falls below the temperature threshold.
